(19) United States
(12) Patent Application Publication
(10) Pub. No.: US 2013/0117134 A1
(43) Pub. Date: May 9, 2013

(54) SYSTEM AND METHOD FOR DELIVERY AND USE OF ADVERTISING CONTENT

(71) Applicant: Opanga Networks, Inc., Seattle, WA (US)

(72) Inventors: John M. Burnette, Seattle, WA (US); David B. Gibbons, Redmond, WA (US); Jeffrey P. Harrang, Sammamish, WA (US); Linh Nguyen, Bothell, WA (US); Cindy Cardona Vicario, Monterrey (MX); Hugo de Jesus Garza Gomez, Monterrey (MX); Jesus Hector Dominguez Sanchez, El Rosario (MX); Oscar Leonardo Garcia Guzman, Smyrna, TN (US)

(73) Assignee: Opanga Networks, Inc., Seattle, WA (US)

(21) Appl. No.: 13/667,799

(22) Filed: Nov. 2, 2012

Related U.S. Application Data
(60) Provisional application No. 61/555,944, filed on Nov. 4, 2011.

(51) Int. Cl. G06Q 30/02

(52) U.S. Cl. 705/14.73

(57) ABSTRACT

Pre-delivery or “pre-positioning” of advertising content to client computing devices for later playback thereon when users of the client computing devices are consuming non-advertising content. The pre-delivery may be accomplished using transport technology that avoids further burdening the network, such as delivering in real-time using available surplus network capacity. Users may have a limited number of times to watch non-advertising content on a client computing device before a pre-positioned advertisement is played on their client computing device. The advertising content may be viewed instantly without delay since it has been pre-positioned to the client computing devices. Advertising viewing statistics and reports are also generated and distributed.

### BACKGROUND OF THE INVENTION

1. Field of the Invention

The present disclosure is directed generally to content provisioning and, more particularly, to a system and method for delivery and use of advertising content.

2. Description of the Related Art

Advertising has become a significant mechanism to promote products or services, if not the most important way of positioning a company or product in people's minds. In order to achieve this brand recognition, advertisements are displayed through different media types to reach the largest number of customers or potential customers. The recent and rapid widespread expansion of mobile users and mobile media applications represents a new opportunity for companies that want to achieve an even greater number of potential customers. Taking this into account, content providers and application developers benefit from showing advertisements through their applications. However, this rapid growth in mobile users has primarily relied on advertisement (“ad”) videos delivered to the final consumer using a streaming method which can suffer during frequent network congestion. One common outcome: the users have to spend more time than needed to watch an ad that is slowly buffered before finally being played. Further, because advertisements (“ads”) are often streamed over congested networks, consumers not only have to watch ads, but they have to wait for them to buffer and unfreeze. Given this and other related quality of experience problems with streaming, the current delivery of such ads to their applications is not done in an efficient way. This is problematic for both consumer and advertiser.

### BRIEF DESCRIPTION OF THE SEVERAL VIEWS OF THE DRAWINGS

FIG. 1 illustrates an exemplary embodiment of a system architecture constructed in accordance with the present disclosure.

FIG. 2 illustrates a block diagram of a personal computing device (PCD) according to an embodiment.

FIG. 3 illustrates a block diagram of a media content provider (MCP) according to an embodiment.

FIG. 4 illustrates an advertising content server (ACS) according to an embodiment.

FIG. 5 illustrates a flow chart for a process of pre-positioning advertising content on a client computing device.

FIG. 6 illustrates a flow chart for a process of receiving and playing a pre-positioned advertisement on a client computing device.

### DETAILED DESCRIPTION OF THE INVENTION

As used herein, pre-positioned digital content refers to online content that is delivered (i.e., positioned) in part or in its entirety to a client computing device and stored on a memory thereof for consumption by a user at a later time independent of the time of delivery. This is contrasted with streaming content or progressive download content that is delivered to a client computing device for immediate playback (i.e., “real-time” or “on demand” playback). One example of pre-positioned digital content is a video file that is downloaded and stored on a client computing device, such as a fixed or mobile unit with playback capability, and watched by the user sometime after it has been pre-positioned and stored (e.g., one hour later, one week later, etc.).

Many online media content sources are freely available to the public via web browsers that stream content directly from the source web server. Often the cost of providing the service is supplemented by interspersed advertising content videos or “clips” with the subject media (non-advertising content). Ads are displayed to the user in a variety of forms, including static and animated banner ads, videos, etc. The ads presented to a given user may be selected from a larger pool of ads and chosen at random or based on profile information about the user. This process is referred to as “rotating ads.”

The current model assumes that the user contacts the streaming server directly via his or her web browser and selects the media of interest for real-time or near-real-time streaming. The random ad selection is therefore triggered by the content request by the user and occurs based on server-end business logic.

In contrast, pre-positioned content is already delivered to and stored on the client computing device at the time the user selects the content for viewing or listening. If the content provider (e.g., content source or unrelated distributor) wishes to make a source of publically available content available via pre-positioning, then it is often mandatory to preserve the advertisements and rotation features. It is therefore desirable to have ways to implement rotating ads with pre-positioned content, as discussed below.

In accordance with embodiments of the present invention, advertising content (e.g., a video clip) can be delivered to a client computing device and played instantly thereon at a later time by using a method of pre-delivery (also referred to herein as “pre-positioning”) of advertising content for later playback by the user. In some embodiments, this is accomplished using transport technology that avoids further burdening the network such as delivery in real-time using available surplus network capacity. This solution takes the burden off the network traffic to pre-position ads to client computing devices. Systems and methods for delivery using available surplus network capacity are disclosed in commonly owned U.S. Pat. No. 7,500,010, titled “Adaptive File Delivery System and Method,” by Harrang et al., filed Apr. 15, 2010, and U.S. Patent Pub. No. 2009/0164603, titled “Adaptive File Delivery System and Method,” by Harrang et al., filed Feb. 27, 2009, each of which are incorporated herein by reference.

As discussed further below, embodiments of the present invention utilize an advertising content server (ACS) to retrieve advertising content from a media content provider (MCP) (or “media content server”), and to pre-position the advertising content to one or multiple client computing devices belonging to users that in an embodiment have subscribed or otherwise selected a corresponding “channel.”

In some embodiments, the system may track the number of view counts by a user on a particular channel. Users may have a limited number of times to watch any non-advertising content (e.g., videos of news, information, sports, entertainment, etc.) corresponding to a “channel” before they are forced to view an ad. For example, users may be forced to view an ad for every five videos they watch on one or more channels.

Once an ad is completely played, the viewing statistics for the ad can be monitored and recorded. As an example, one such viewing statistic is how many times an ad is played. Another example of a viewing statistic is how many times an ad is skipped or interrupted. This information may be used to generate one or more reports for periodic distribution (e.g., once a day), as discussed further below.

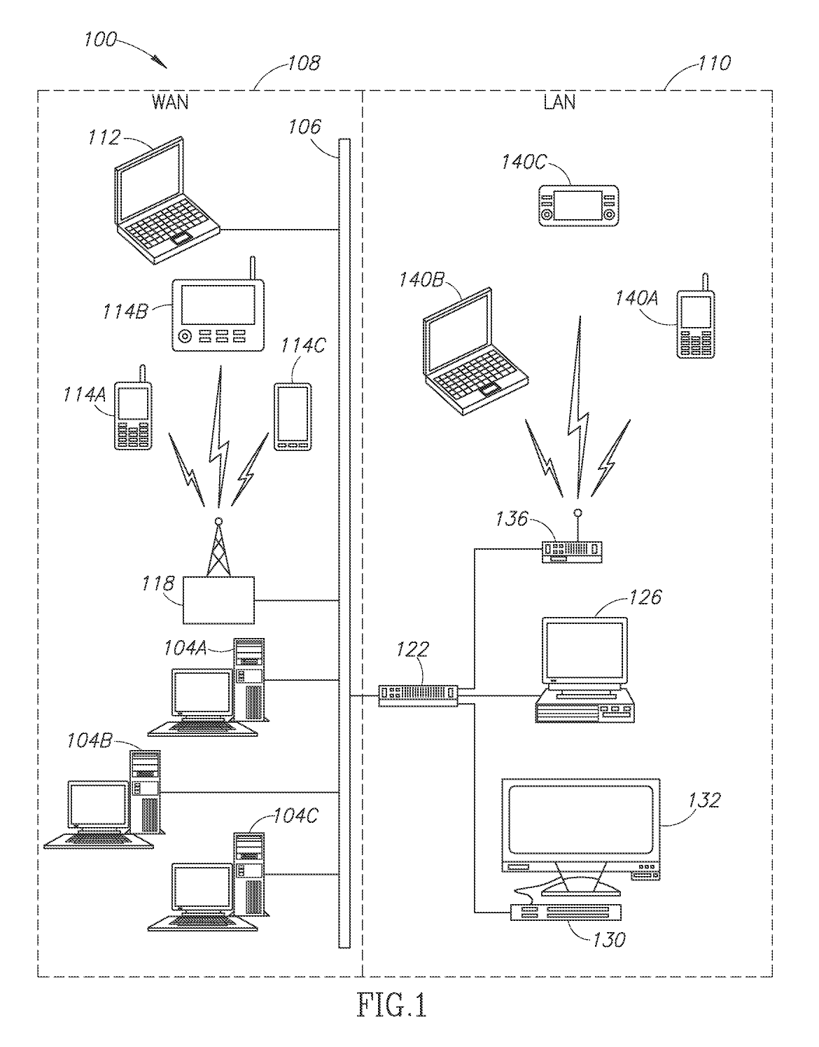

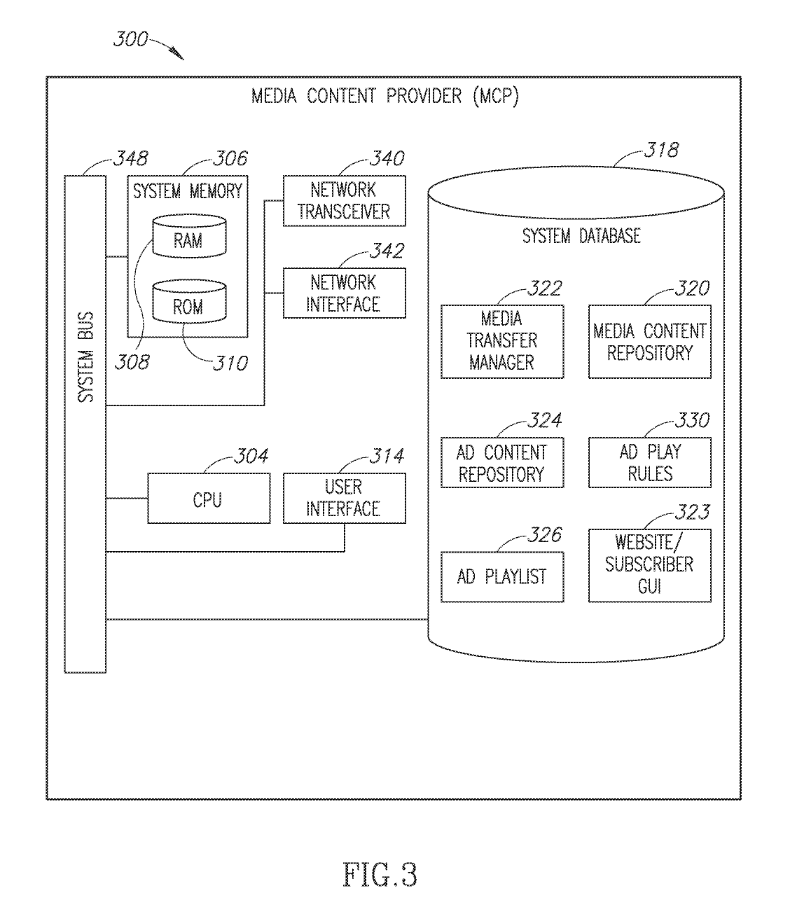

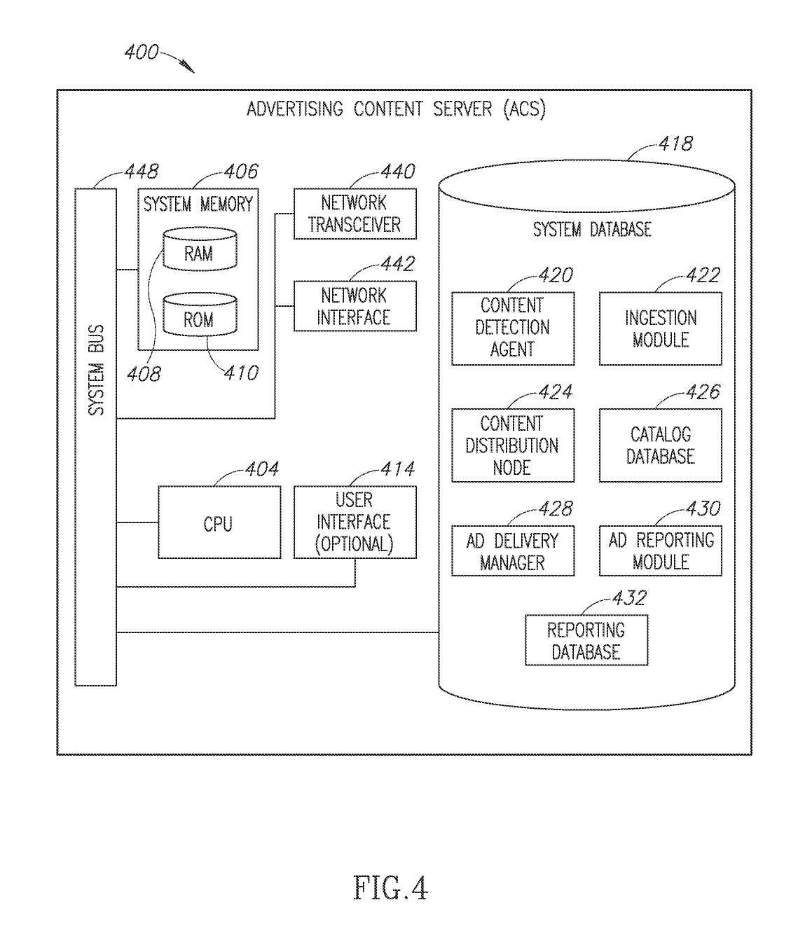

In accordance with an embodiment of the present invention, FIG. 1 illustrates a networked computing system 100 including various wire line and wireless computing devices that may be utilized to implement any of the content delivery processes associated with various embodiments of the present invention. The networked computing system 100 may include, but is not limited to, a group of remote server devices 104A-C, any one of which may be associated with various media content providers (MCPs) (see FIG. 3) that can provide media content distribution services to various networked clientele, or various advertising content servers (ACS) (see FIG. 4) that can facilitate managed pre-positioned delivery of advertising content in accordance various processes of the present invention. The networked computing system 100 also includes a data communications network 106 (including both wide area network (WAN) 108 and local area network (LAN) 110 portions), one or more remote client devices 112, and one or more wireless remote client devices 114 (e.g., a cellular phone 114A, an electronic book device 114B, a PDA device 114C, etc.) that may be connected to the data communications network 106 utilizing one or more wireless base stations 118 or any common wireless or wire line network communications technology.

The networked computing system 100 may also include one or more network gateway or switch devices 122 that can facilitate data communications processes within the LAN 110 or between the LAN and the WAN 108 of the data communications network 106. Generally, the gateway or switch device 122 may represent any device configured to allow other devices to access the data communications network 106 (e.g., service provider gateway, etc.). The network gateway or switch device 122 may facilitate data communications with one or more wired LAN devices, such as a personal computer 126, a multi-media device 130 (e.g., such as a set-top box, digital video recorder (DVR), Blu-Ray® player, and/or a digital video disk (DVD) player/recorder device) for use with a television 132, etc. The networked computing system 100 may further include a wireless router 136 that may communicate with various wireless LAN devices 140 using any common local wireless communications technology, such as Wi-Fi®, etc. Such wireless LAN devices may include, for example, a smartphone device 140A, a wireless computer 140B, and a wireless media playback device 140C (e.g., a personal video player, an e-book device, etc.).

In various embodiments, any of the LAN connected devices 126, 130, and 140A-C or the remote client devices 112 and 114A-C, may include advertising management functionality consistent with the processes of the present invention, as discussed below.

The remote server devices 104A-C, the wireless base station 118, the remote client devices 112 and 114A-C, and any of the LAN connected devices 126, 130, and 140A-C, may be configured to run any known operating system.

Further, the remote server devices 104A-C and the wireless base station 118 may employ any number of common server, desktop, laptop, and personal computing devices. In an embodiment, the remote client devices 114A-C and any of the wireless LAN connected devices 140A-C may include any combination of computing devices (e.g., cellular phones, PDAs, eBooks, ultra-portable computers, personal music players, etc.), having wireless communications capabilities utilizing any common cellular data commutations protocol, such as GSM®, UMTS®, Imax®, Wi-Fi®, LTE®, or other protocol.

The WAN 108 of the data communications network 106 may include, but is not limited to, any of the following communications technologies: optical fiber, coaxial cable, twisted pair cable, Ethernet cable, and power line cable, along with any wireless communication technology known in the art. In an embodiment, any of the remote server devices 104A-C, the wireless base station 118, the remote client devices 112 and 114A-C, and any of the LAN connected devices 126, 130, and 140A-C, may include any standard computing software and hardware necessary for processing, storing, and communicating data amongst each other within the networked computing system 100. The computing hardware may include, but is not limited to, one or more processors, volatile and non-volatile memories, user interfaces, transcoders, and wire line and/or wireless communications transceivers.

Any of the LAN connected devices 126, 130, and 140A-C or the remote client devices 114A-C may be configured to include one or more computer-readable media (e.g., any common volatile or non-volatile memory type) encoded with a set of computer readable instructions which, when executed, performs one or more data transfer and/or advertisement management functions associated with any of the processes of the present invention.

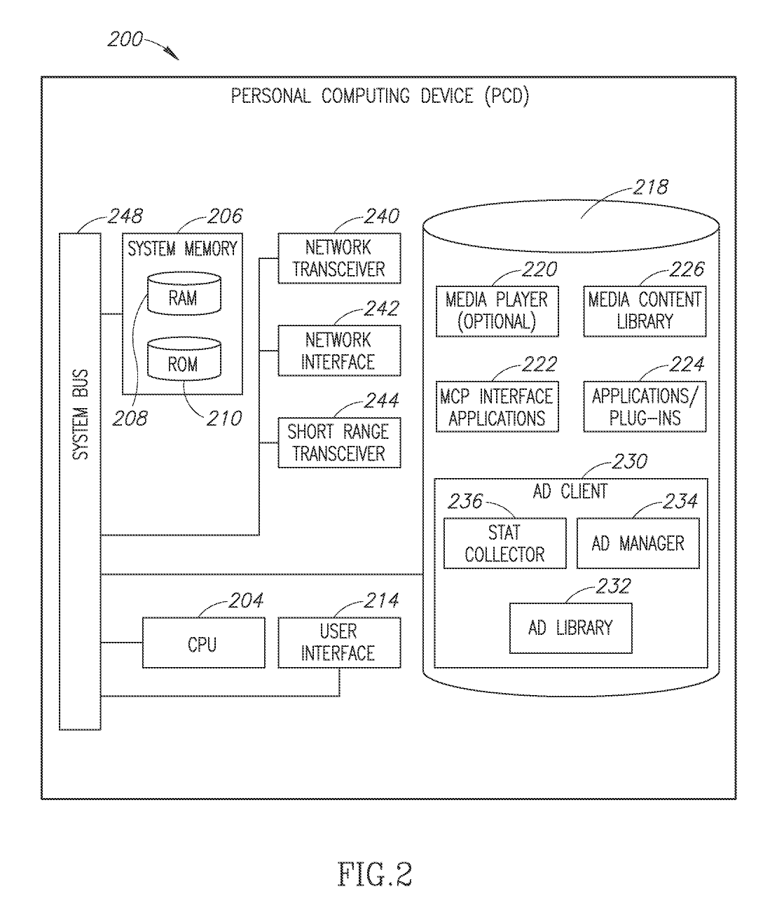

FIG. 2 shows a block diagram view of a personal computing device (PCD) 200 that may be representative of any of the LAN connected personal computing devices 126, 130, and 140A-C or the remote client devices 112 and 114A-C shown in FIG. 1. The PCD 200 may include, but is not limited to, one or more processor devices including a central processing unit (CPU) 204. The CPU 204 may be responsible for executing computer programs stored on the PCD's 200 system memory 206, which may include volatile (RAM) memory 208 and nonvolatile (ROM) memory 210. The PCD 200 may also include a user interface 214 that allows a user to interact with the PCD's software and hardware resources. The user interface 214 may include various inputs (e.g., keyboard, mouse, touchscreen, microphone, etc.) and outputs (e.g., display, speakers, etc.).

The PCD 200 further includes a system data storage structure 218 that includes an optional media player application 220 that facilitates media content playback on the PCD 200, and MCP interface applications 222 that may be optionally integrated with an MCP website interface to allow a user to select media content for download from or upload to an MCP (e.g., a network location associated with any of remote server devices 104A-C of FIG. 1). In general, the system data storage structure 218 may include applications and/or application plug-ins 224 (e.g., web-browsers, browser plug-ins, email client applications, access provider utilities, etc.) that may facilitate a user of the PCD 200 interacting with various media content providers (MCPs) (see FIG. 3) over the data communications network 106 of FIG. 1.

The system data storage structure 218 may also include a media content library 226 that includes a user's downloaded, or otherwise acquired, digital media content (e.g., digital movies, TV programs, home video, software applications, video games, music, e-books, etc.). The system data storage structure 218 also includes an ad client application 230 including an ad library database 232, an ad manager 234, and a statistics collector 236. These components are described in further detail below.

The PCD 200 may also include a network transceiver 240 and a network interface 242 that allow the PCD 200 to communicate across the LAN 110 and WAN 108 portions of the data communications network 106 of FIG. 1. The PCD 200 may also include an optional short-range transceiver 244 (e.g., a Bluetooth® or a Wi-Fi® enabled communications transceiver) that allows the PCD 200 to wirelessly communicate with one or more electronic devices. Further, the PCD 200 may include a system bus 248 that facilitates data communications amongst all the hardware resources of the PCD 200.

FIG. 3 shows a block diagram view of a media content provider (MCP) 300 that may be representative of any of the remote server devices 104A-C in FIG. 1. The MCP 300 may include, but is not limited to, one or more processor devices including a central processing unit (CPU) 304. The CPU 304 is generally responsible for executing computer programs stored on the MCP's 300 system memory 306, which may include volatile (RAM) memory 308 and nonvolatile (ROM) memory 310. The MCP 300 may also include a user interface 314 that allows a user/administrator to interact with the MCP's software and hardware resources.

The MCP 300 also includes a system database 318 that includes a media content repository 320, as well as a hosted website 323 including various graphical user interface (GUI) components (e.g., static html and dynamic components, such as java-based applications) that may facilitate a user making media content selections for purchase and download. The MCP 300 may also include a network transceiver 340 and a network interface 342 for transmitting and receiving data content (e.g., such as media content to be delivered to a client computing device) over the data communication network 106 of FIG. 1. The MCP 300 may also include a system bus 348 that facilitates data communications amongst the hardware resources of the MCP 300.

The system database 318 of the MCP 300 may also include a media content transfer manager application 322 to facilitate delivery of various media content data files (e.g., movies, TV programs, home video, software applications, video games, music, large volumes of text, etc.) stored in the MCP's 300 media content repository 320 in response to various media content transfer requests. The media content transfer manager application 322 may also facilitate generation and delivery of various media content properties/characteristics, such as a particular media content's file size, length, type, location of content source, number of network hops to content sources, content source network address, user authentication and/or authorization credentials, or available transfer protocol (e.g., ftp, http, https, smtp, pop3, imap, p2p, etc.).

The system database 318 of the MCP 300 may also include an ad content repository 324 that stores advertising content data files (e.g., videos, images, banners, etc.). An ad playlist database 326 may also be provided that stores current playlists of advertisements to be presented with delivered non-advertising media content. Further, the system database 318 may include ad play rules database 330 that includes rules or instructions that indicate when an ad should be played on a user's client computing device. For example, for a particular non-advertising media content channel or a particular user, the ad play rules in the ad play rules database 330 may indicate that an advertisement should be played after three non-advertising media content files have been played on a client computing device. In other words, the ad play rules may specify that an ad play ratio of non-advertising content views to advertising content views should be 3:1. As another example, the ad play rules may specify that an advertisement should be played for every X minutes (e.g., 5 minutes, 60 minutes, etc.) of non-advertising content played. As yet another example, the ad play rules may specify that an advertisement should be played only during the hours of 8 pm to 11 pm daily, only during weekdays, etc. Of course, other ad play rules may also be used.

FIG. 4 shows a block diagram view of an advertising content server (ACS) 400 that may be representative of any of the remote server devices 104A-C in FIG. 1. The ACS 400 may include, but is not limited to, one or more processor devices including a central processing unit (CPU) 404. The CPU 404 of the ACS 400 is generally responsible for executing computer programs stored on the ACS's system memory 406, which may include volatile (RAM) memory 408 and nonvolatile (ROM) memory 410. The ACS 400 may also include a user interface 414 that allows a user/administrator to interact with the ACS's software and hardware resources. The ACS 400 may also include a network transceiver 440 and network interface 442 for transmitting and receiving data content (e.g., such as advertising content to be delivered to a client computing device) over the data communication network 106 of FIG. 1. The ACS 400 may also include a system bus 448 that facilitates data communications amongst the hardware resources of the ACS 400.

The ACS 400 also includes a system database 418 that includes a content detection agent (CDA) 420, an ingestion module 422, a content distribution node 424, a catalog database 426, an ad delivery manager 428, an ad reporting module 430, and a reporting database 432. Each of these components is discussed below.

In order to obtain the necessary ads to distribute to each of the client computing devices, the content detection agent (CDA) 420 is provided. The CDA 420 obtains ads from the ad playlist database 326 that the media content provider 300 utilizes (e.g., at its web site). The ad playlist database 326 may be periodically checked by the CDA 420 to look for new ads that might have been added by the MCP 300. Each time the CDA 420 finds a new ad for a given MCP 300 that has not been previously “ingested” into the ACS 400, the CDA retrieves the ad from that MCP.

Once ads have been detected and retrieved by the CDA 420, the ingestion module 422 executes an ingestion process that includes saving the relevant information that is contained in the ad playlist database 326 for each of the retrieved ads in the catalog database 426. The ingestion process may also include managing the generation of orders of ads for the client computing devices subscribed to a corresponding channel for the ads. In some embodiments, the ingestion process may further include retrieving from the MCP 300 the ad play rules associated with the ads.

The ad delivery manager 428 is responsible for fetching an ad from the catalog database 426 and pre-positioning the ad to client computing devices (e.g., the PCD 200 of FIG. 2) via the content distribution node 424 when the client computing devices request an ad. To avoid stressing the data communications network 106 of FIG. 1, in some embodiments the ads are delivered using substantially only available surplus capacity of the network, as discussed above.

In addition to delivering ads without stressing the network, the ad delivery manager 428 may also retrieve the ad play rules from the ad play rules database 330 of the MCP 330 and deliver the ad play rules to the client computing devices. The ad play rules may define the number of “free plays” of non-advertising content before forcing the viewing of an ad. This number determines how many times the users can watch non-advertising media content (e.g., news video, etc.), regardless of replays, without being interrupted by an ad. As the number of plays of non-advertising media content on a client computing device reaches the maximum free plays allowed, the user is forced to watch an ad before he or she can view or listen to the next non-advertising media content. This number is configurable and can vary among different channels, user subscriptions, etc. For example, the number may vary based on a user profile for a user that subscribes to a particular channel.

Once the advertising content is distributed to each of the client computing devices, the ad reporting module 430 receives periodic ad reports from the statistics collector module 236 of the ad client application 230 running on each of the PCDs 200, as discussed in further detail below. When the ad reporting module 430 receives a new ad report from the statistics collector module 236, it saves the information contained in the report in the reporting database 430. An example set of information that can be contained in an ad report includes, but is not limited to: view count for a given ad; ad identification; electronic serial number (ESN) from the device that sent the ad report; and the time when the report was received.

An ad report may also include information regarding one or more ads. For example, with the data sent by the statistics collector module 236 of multiple client applications 230, the ad reporting module 430 may create reports containing the information available for each of the ads that have been played.

These statistics also give the ad reporting module 430 the ability to display several graphs that illustrate important tendencies, such as the “top-ten” ads, the devices (users) that watched more ads, etc. These reports may be analyzed and distributed to other entities, such as the MCP 300, advertisers, or other interested parties.

When a user subscribes to a channel (e.g., associated with the MCP 300), an ad service for that channel may be subscribed to automatically without further user interaction. Every channel may have its own number of free plays, determined by the ad play rules received from the ad play rules database 330 of the MCP 300. As discussed above, the user is required to watch an ad after he or she plays non-advertising content files the configured number of free-play times allowed.

Referring back to the PCD 200 of FIG. 2, the ad client application 230 manages ads incoming from the ACS 400 using the ad manager 234, and collects the ads' viewing statistics using the statistics collector module 236.

The ad manager 234 manages the ad library database 232, which stores the ads for the currently-subscribed channels for the PCD 200. The ad manager 234 notifies the ad delivery manager 428 of the ACS 400 when an ad is required for any channel to which the user has subscribed. Using the process described above, the ad contents are pre-positioned onto the PCD 200 by the ACS 400. The ad manager 234 then stores the downloaded ad along with ad information received from the ACS 400 in the ad library database 232. Such ad information may include, for example, ad identification, title, duration, air date, air times, and expiration date. In addition to these data, the ad manager 234 may also track how many times and when an ad is played on the PCD 200 and how many times and when an ad is skipped or interrupted.

Furthermore, the ad manager 234 decides when to download an ad. In some instances, due to limited space and network bandwidth, the ad manager 234 may selectively identify and cease downloading ads for channels that the user is not watching very often. Therefore, in this example, the ad manager 234 only notifies the ad delivery manager 428 of the ACS 400 to pre-position another available ad after a previously pre-positioned ad is requested to be played. In some embodiments, each channel may have its own ordered ad queue or playlist. The ad queue may be ordered by the ads that have been played the least followed by the ads having the newest air date, for example. This ensures that all of the ad contents eventually are viewed and rotated in sequential order. Other ordering schemes may also be used.

Periodically, the statistics collector module 236 of the PCD 200 may request the ad manager 234 to provide a list of all of the ads that were played or skipped or interrupted in a previous time period (e.g., the last X hours). The ad manager 234 may then generate a list of ads from the ad library database 232 along with information for each ad. Such information may include, but is not limited to, ad identification and the number of times an ad is played or skipped or interrupted. The list of ads and ad information may then be sent to the ad reporting module 430 in the ACS 400 in the form of a report. When the report is sent successfully, the ad library database 232 may then reset all the play counts of the ads listed in the report.

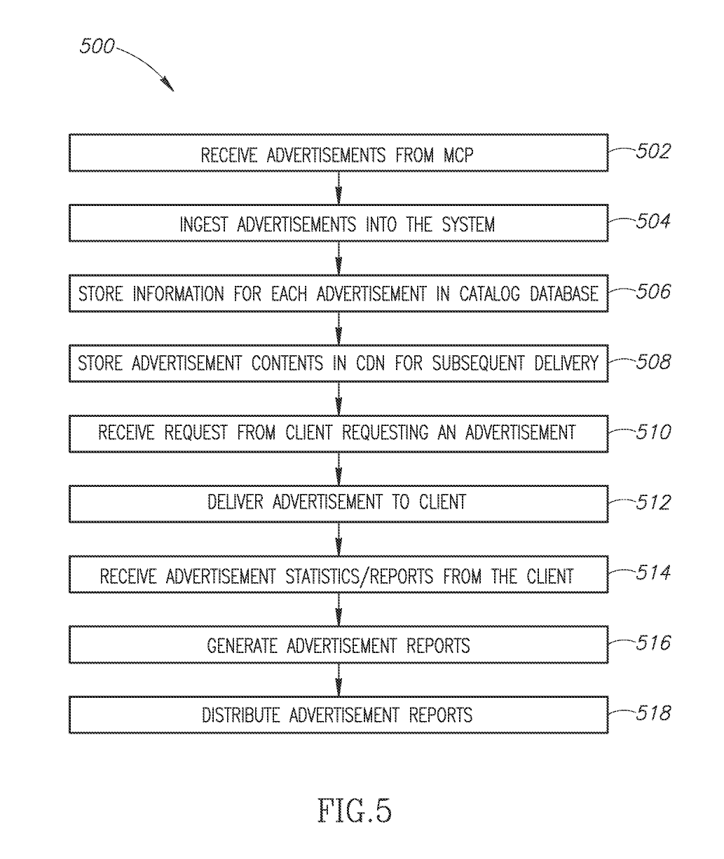

FIG. 5 illustrates a flow chart of a process 500 for pre-positioning an ad on the PCD 200 of FIG. 2 utilizing the ACS 400 of FIG. 4 and the MCP 300 of FIG. 3. Initially, the content detection agent (CDA) 420 of the ACS 400 receives one or more ads from the MCP 300, block 502. The ads are then ingested into the ACS 400 using the ingestion module 422, block 504. The CDA 420 also retrieves information from the ad playlist database 326 for each ad and saves the information in the catalog database 426 for later use, block 506. The ad contents are stored in the content distribution node (CDN) 424 so that they are ready to be distributed to one or more PCDs 200, block 508.

The ad delivery manager 428 receives a request from the ad manager 234 of the client ad application 230 requesting a new ad, block 510. A new ad is delivered to the PCD 200 along with relevant information for the ad, block 512, where it may be stored for later playback on the PCD. Alternatively, in some embodiments the new ad may be pushed to the PCD 200 along with relevant information for the ad without the ad manager 234 requesting a new ad (i.e., skipping block 510).

Periodically, the ad reporting module 430 receives ad reports from the statistics collector module 236 of the ad client application 230 executing on the PCD 200, block 514. In some embodiments the ad reports may be first requested by the ad reporting module 430 from the statistics collector module 236. The ad reporting module 430 saves the reports/statistics in the reporting database 430, so that future reports may be generated and/or distributed to other entities, such as the owners of the advertisements, the MCP 300, etc., blocks 516 and 518.

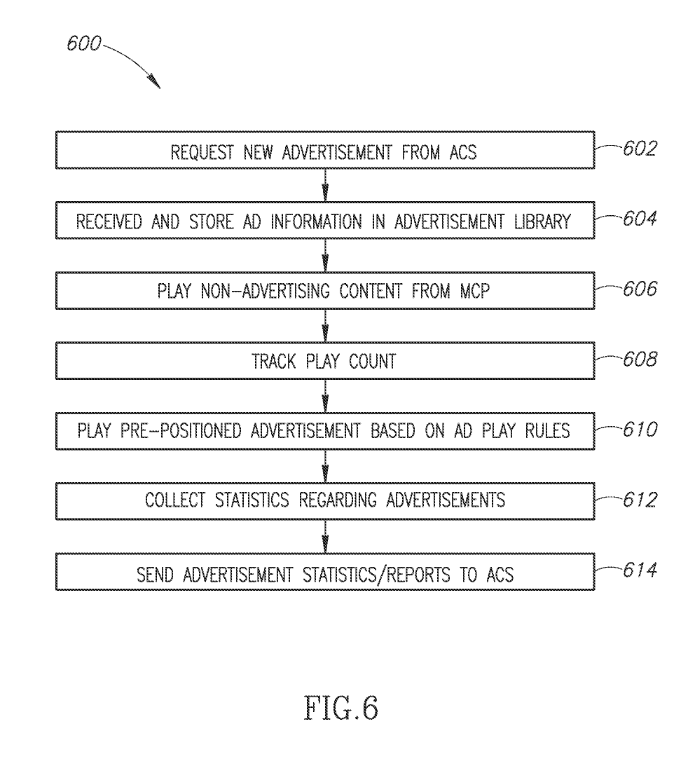

FIG. 6 illustrates a flow chart of a process 600 for receiving and playing a pre-positioned ad on the PCD 200. Initially, the ad manager 234 of the ad client application 230 decides to get a new ad and requests the new ad from the ACS 400, block 602. The ad manager 234 receives the ad and its corresponding information (e.g., ad play rules) and stores the data in the ad library database 232 so that it can be subsequently used, block 604. These steps can be transparent to the user and do not occur in response to any requests from the user.

The PCD 200 may then proceed to play non-advertising content received from the MCP 300, block 606. For example, the non-advertising content may comprise videos streamed from the MCP 300 to the PCD 200. In another example, the non-advertising content may comprise videos pre-delivered from the MCP 300, block 606. As the user is viewing non-advertising content for a particular channel or group of channels associated with the MCP 300, the ad manager 234 tracks the play count and compares the play count to the ad play rules for the channel or group of channels, block 608. In an example, once the user reaches the maximum number of “free plays” (or minutes) according to the ad play rules from the ad play rules database 330, the ad manager 234 is triggered to retrieve a pre-positioned ad that belongs to the channel that the user is currently watching. The ad is then played without interruption on the PCD 200, block 610. The process of sequentially playing non-advertising content and ad content may be repeated as long as the user continues to consume content on the PCD 200.

In some embodiments the PCD 200 may proceed to play non-advertising content received from the MCP 300, block 606, by first playing ad content received from the ACS 400 followed by the non-advertising content.

As discussed above, the statistics collector module 236 is responsible for collecting the ads' information, including view counts, and sending the statistics and/or reports to the ad reporting module 430 of the ACS, blocks 612 and 614.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediary components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A networked computing system for pre-positioning advertising content files to one or more client computing devices over a data communications network, the networked computing system comprising:
an advertising content server comprising:
a data storage structure configured to store advertising content files and associated ad play rules;
an ad delivery manager configured to pre-position one or more of the advertising content files and associated ad play rules on the one or more client computing devices over the data communications network; and
a client computing device configured to communicate with a content provider server and the advertising content server over the data communications network, the client computing device running a client application configured for receiving the pre-positioned one or more advertising content files and ad play rules from the ad delivery manager and storing the one or more advertising content files and ad play rules on a data storage structure of the client computing device for display at a later time, the client application further configured to:
display on a display of the client computing device non-advertising content received from the content provider server;
monitor the display of the non-advertising content for a condition indicated by the ad play rules; and
display a selected one of the pre-positioned advertising content files stored in the data storage structure of the client computing device according to the received ad play rules.

2. The networked computing system of claim 1 wherein the advertising content server further comprises:
a content detection agent configured to communicate over the data communications network with the content provider server, the content detection agent being configured to receive the one or more advertising content files from the content provider server.

3. The networked computing system of claim 2 wherein the content detection agent is further operative to receive an ad playlist from the content provider server over the data communications network, and to receive advertising content files from the content provider server dependent on the received ad playlist.

4. The networked computing system of claim 1 wherein the ad play rules correspond to a maximum number of non-advertising content files that are to be displayed before an advertising content file is displayed.

5. The networked computing system of claim 1 wherein the ad play rules correspond to a maximum amount of time non-advertising content files are to be displayed before an advertising content file is displayed.

6. The networked computing system of claim 1 wherein the ad delivery manager is configured to receive the ad play rules from the content provider server.

7. The networked computing system of claim 1 wherein the ad delivery manager is configured to receive a request from the client application running on the client computing device for delivery of one or more of the advertising content files over the data communications network, and is further configured to send the one or more advertising content files to the client computing device over the data communications network in response to the received request.

8. The networked computing system of claim 1 wherein the ad delivery manager is configured to push the one or more advertising content files to the client computing device over the data communications network without first receiving a request from the client application running on the client computing device.

9. The networked computing system of claim 1 wherein ad delivery manager is configured to send the one or more advertising content files to the one or more client computing device over the data communications network using substantially only surplus network capacity.

10. The networked computing system of claim 1 wherein the advertising content files and the non-advertising content files comprise video files.

11. The networked computing system of claim 1 wherein the client application comprises a statistics collector module configured to record advertising content statistics comprising the number of times an advertising content file is displayed on the display of the client computing device.

12. The networked computing system of claim 11 wherein the statistics collector module of the client application is configured to generate a report relating to advertising content statistics for a plurality of advertising content files.

13. The networked computing system of claim 11 wherein the advertising content server further comprises an ad reporting module configured to receive advertising content statistics from the statistics collector module of the client application over the data communications network.

14. The networked computing system of claim 13 wherein the ad reporting module is configured to send reports to a computing device over the data communications network.

15. The networked computing system of claim 1, wherein the ad play rules are configurable and are dependent on at least one of: a channel with which the one or more non-advertising content files are associated; and a user profile associated with a user of the client computing device.

16. A computer-implemented method comprising:
pre-positioning an advertising content file and associated ad play rule to a client computing device over a data communications network;
storing the pre-positioned advertising content file and associated ad play rule on a data storage structure of the client computing device for display on a display thereof at a later time;
monitoring, on the client computing device, the display of one or more non-advertising content files on the display of the client computing device received from a content provider server for a condition indicated by the ad play rule; and
displaying the pre-positioned advertising content file on the display of the client computing device in accordance with the ad play rule.

17. The computer-implemented method of claim 16, further comprising:
receiving the advertising content file and associated ad play rule from the content provider server over the data communications network; and
storing the advertising content file and associated ad play rule in a data storage structure of an advertising content server.

18. The computer-implemented method of claim 15, further comprising receiving an ad playlist from the content provider server over the data communications network, and receiving an advertising content file from the content provider server dependent on the received ad playlist.

19. The computer-implemented method of claim 16 wherein the ad play rule corresponds to a maximum number of non-advertising content files that are to be displayed before an advertising content file is displayed.

20. The computer-implemented method of claim 16 wherein the ad play rule corresponds to a maximum amount of time non-advertising content files are to be displayed before an advertising content file is displayed.

21. The computer-implemented method of claim 16, further comprising receiving a request from the client computing device for delivery of the advertising content file thereto over the data communications network and sending the advertising content file and associated ad play rule to the client computing device over the data communications network in response to the received request.

22. The computer-implemented method of claim 16, wherein pre-positioning the advertising content file and associated ad play rule to the client computing device over the data communications network comprises pushing the advertising content file to the client computing device over the data communications network without first receiving a request from a client application running on the client computing device

23. The computer-implemented method of claim 16 wherein pre-positioning the advertising content file and associated ad play rule comprises sending the advertising content file and associated ad play rule to the client computing device over the data communications network using substantially only surplus network capacity.

24. The computer-implemented method of claim 16 wherein the advertising content file and the non-advertising content files comprise video files.

25. The computer-implemented method of claim 16 wherein the one or more non-advertising content files displayed on the display of the client computing device are streamed from the content provider server to the client computing device over the data communications network.

26. The computer-implemented method of claim 16 wherein the one or more non-advertising content files displayed on the display of the client computing device are pre-delivered from the content provider server to the client computing device over the data communications network.

27. The computer-implemented method of claim 16, further comprising recording, at the client computing device, advertising content statistics comprising the number of times the advertising content file is displayed.

28. The computer-implemented method of claim 27, further comprising generating, at the client computing device, a report comprising advertising content statistics for a plurality of advertising content files.

29. The computer-implemented method of claim 28, further comprising sending the report to the content provider server over the data communications network.

30. The computer-implemented method of claim 16, wherein the ad play rule is configurable and is dependent on at least one of: a channel with which the one or more non-advertising content files are associated; and a user profile associated with a user of the client computing device.

31. A non-transitory computer-readable medium encoded with computer executable instructions, which when executed, performs a method comprising:
pre-positioning an advertising content file and associated ad play rule to a client computing device over a data communications network;
storing the pre-positioned advertising content file and associated ad play rule on a data storage structure of the client computing device for display on a display thereof at a later time;
monitoring, on the client computing device, the display of one or more non-advertising content files on the display of the client computing device received from a content provider server for a condition indicated by the ad play rule; and
displaying the pre-positioned advertising content file on the display of the client computing device in accordance with the ad play rule.

32. The non-transitory computer-readable medium of claim 31 wherein the ad play rule corresponds to a maximum number of non-advertising content files that are to be displayed before an advertising content file is displayed.

33. The non-transitory computer-readable medium of claim 31 wherein the ad play rule corresponds to a maximum amount of time non-advertising content files are to be displayed before an advertising content file is displayed.

34. The non-transitory computer-readable medium of claim 31, wherein the method further comprises receiving a request from the client computing device for delivery of the advertising content file over the data communications network and sending the advertising content file and associated ad play rule to the client computing device over the data communications network in response to the received request.

35. The non-transitory computer-readable medium of claim 31, wherein pre-positioning the advertising content file and associated ad play rule to the client computing device over the data communications network comprises pushing the advertising content file to the client computing device over the data communications network without first receiving a request from a client application running on the client computing device.

36. The non-transitory computer-readable medium of claim 31 wherein pre-positioning the advertising content file and associated ad play rule comprises sending the advertising content file and associated ad play rule to the client computing device over the data communications network using substantially only surplus network capacity.

37. The non-transitory computer-readable medium of claim 31 wherein the advertising content file and the non-advertising content files comprise video files.

38. The non-transitory computer-readable medium of claim 31 wherein the one or more non-advertising content files displayed on the display of the client computing device are streamed from the content provider server to the client computing device over the data communications network.

39. The non-transitory computer-readable medium of claim 31 wherein the one or more non-advertising content files displayed on the display of the client computing device are pre-delivered from the content provider server to the client computing device over the data communications network.

40. The non-transitory computer-readable medium of claim 31, wherein the method further comprises recording, at the client computing device, advertising content statistics comprising the number of times the advertising content file is displayed.

41. The non-transitory computer-readable medium of claim 40, wherein the method further comprises generating, at the client computing device, a report comprising advertising content statistics for a plurality of advertising content files.

42. The non-transitory computer-readable medium of claim 41, wherein the method further comprises sending the report to the content provider server over the data communications network.

43. The non-transitory computer-readable medium of claim 31, wherein the ad play rule is configurable and is dependent on at least one of: a channel with which the one or more non-advertising content files are associated; and a user profile associated with a user of the client computing device.
